(19) United States
(12) Patent Application Publication
(10) Pub. No.: US 2026/0148207 A1
(43) Pub. Date: May 28, 2026

(54) Method, System, and Computer Program Product for Identifying Sub-Merchants Within a Global Merchant Repository

(71) Applicant: Visa International Service Association, San Francisco, CA (US)

(72) Inventors: Yogesh Kumar, Bangalore (IN); Aditya Natani, Bangalore (IN); Ratan Kumar Pandey, Bangalore (IN); Vishal Kumar, Bangalore (IN); Lakshmi Narayanan Nadathur Vasudevan, Bangalore (IN)

(21) Appl. No.: 19/120,336

(22) PCT Filed: Oct. 16, 2023
(86) PCT No.: PCT/US2023/035189

§ 371 Date: Apr. 11, 2025

(30) Foreign Application Priority Data
Oct. 14, 2022 (IN) 202241058843

(51) Int. Cl. G06Q 20/08

(52) U.S. Cl. CPC G06Q 20/0855

(57) ABSTRACT

Provided are methods for identifying sub-merchants within a Global Merchant Repository (GMR) that include receiving sub-merchant data associated with one or more sub-merchants, from one or more payment facilitators associated with a plurality of sub-merchants, where the sub-merchant data comprises a Card Acceptor Identifier (CAID) associated with each of the one or more payment facilitators, assigning a plurality of pseudo acquirer identifiers to the sub-merchant data received from each of the one or more payment facilitators, and identifying the one or more sub-merchants in the GMR by mapping the sub-merchant data with transaction data associated with a plurality of merchants in the GMR, based on the plurality of pseudo acquirer identifiers and the CAID associated with the respective payment facilitators. Systems and computer program products are also disclosed.

### CROSS-REFERENCE TO RELATED APPLICATIONS

This application is the United States national phase of International Application No. PCT/US23/35189, filed on Oct. 16, 2023, and claims priority to Indian Provisional Patent Application No. 202241058843, filed on Oct. 14, 2022, the disclosures of which are hereby incorporated by reference in their entireties.

### BACKGROUND

### 1. Technical Field

The present disclosure relates, in general, to transaction technologies. Particularly, but not exclusively, the present disclosure relates to methods, systems, and computer program products for identifying the sub-merchants within a Global Merchant Repository (GMR).

### 2. Technical Considerations

Existing merchant onboarding requirements from banks cater to an extensive process which involves managing expensive, complex, and time-consuming activities related to an onboarding process of merchants. However, sub-merchants, such as small enterprises and Small and Medium-sized Businesses (SMBs), are deprived of the onboarding facility due to expenses and complexities involved. Payment facilitators enable the sub-merchants to easily accept online payments. The payment facilitators underwrite and on-board the sub-merchants and then provide them with the necessary technology to process online payments. With the technology provided by the payment facilitators, the sub-merchants or emerging companies no longer require expertise in handling online payments. This allows the sub-merchants to focus on their core purposes.

Payment networks and associated merchant repositories identify brand and location details of the merchants based on acquirer merchant identifiers, which are specifically assigned and utilized to link the merchant and transaction data on the payment networks. However, there are several payment facilitators, which enable the sub-merchants to accept payments without the acquirer merchant identifiers, such as Centre Information Block (CIB), Bank Identification Number (BIN) and Card Acceptor ID (CAID). Consequently, the merchant repositories only receive information about the brand and address of the payment facilitators, but not the address of the actual sub-merchants that are managed by the payment facilitators. The absence of acquirer merchant identifiers causes a major problem in identification of the sub-merchants within the GMRs.

Further, Acquirer Merchant Master File (AMMF) global mandate program requires the payment facilitators to send sub-merchant (or sponsored merchant) data including, but not limiting to, merchant's Doing Business As (DBA) Name, location address, and the like. Unlike the directly acquired merchants, since the merchants sponsored by the payment facilitators do not have the acquirer merchant identifiers, it becomes impossible to link these merchants with transaction data received from the payment networks. Thus, currently, a merchant repository cannot link AMMF data received from the payment facilitators with the corresponding transaction data, thereby creating a major problem in identifying the sub-merchants operating behind the payment facilitators.

The information disclosed in this background of the disclosure section is only for enhancement of understanding of the general background of the present disclosure and should not be taken as an acknowledgement or any form of suggestion that this information forms existing art already known to a person skilled in the art.

The present disclosure is directed to overcome one or more limitations stated above or any other limitations associated with the known arts.

### SUMMARY

One or more shortcomings of the existing system may be overcome, and additional advantages may be provided through the present disclosure. Additional features and advantages may be realized through the techniques of the present disclosure. Other embodiments and aspects of the disclosure are described in detail herein and are considered a part of the present disclosure.

Further non-limiting embodiments or aspects are set forth in the following numbered clauses:

Clause 1: A method for identifying sub-merchants within a Global Merchant Repository (GMR), the method comprising: receiving, by at least one processor and from one or more payment facilitators associated with a plurality of sub-merchants, sub-merchant data associated with one or more sub-merchants and a Card Acceptor Identifier (CAID) associated with each of the one or more payment facilitators; assigning, by the at least one processor, a plurality of pseudo acquirer identifiers to the sub-merchant data received from each of the one or more payment facilitators; and identifying, by the at least one processor, the one or more sub-merchants in the GMR by mapping the sub-merchant data with transaction data associated with a plurality of merchants in the GMR, based on the plurality of pseudo acquirer identifiers and the CAID associated with the respective payment facilitators.

Clause 2: The method of clause 1, wherein the plurality of pseudo acquirer identifiers comprises a Centre Information Block (CIB) and a Bank Identification Number (BIN).

Clause 3: The method of clause 1 or 2, wherein the transaction data comprises a pre-stored CAID associated with the respective payment facilitators, a pre-stored pseudo name, a true name, and pre-stored acquirer identifiers associated with the plurality of sub-merchants.

Clause 4: The method of any of clauses 1-3, further comprising: prior to identifying the one or more sub-merchants in the GMR, eliminating noise data associated with corresponding pseudo names of the sub-merchants based on a predefined pattern matching technique.

Clause 5: The method of any of clauses 1-4, wherein identifying the one or more sub-merchants in the GMR comprises: identifying a name and a location associated with the plurality of sub-merchants by mapping the sub-merchant data and the transaction data based on pseudo names of the sub-merchants and the CAID associated with the respective payment facilitators.

Clause 6: The method of any of clauses 1-5, wherein the sub-merchant data comprises a pseudo name and a predefined name associated with the plurality of sub-merchants.

Clause 7: The method of any of clauses 1-6, further comprising: storing the sub-merchant data associated with the one or more sub-merchants and the CAID associated with each of the one or more payment facilitators in the GMR.

Clause 8: A sub-merchant identification system for identifying sub-merchants within a Global Merchant Repository (GMR), comprising: at least one processor programmed or configured to: receive sub-merchant data associated with one or more sub-merchants, from one or more payment facilitators associated with a plurality of sub-merchants, wherein the sub-merchant data comprises a pseudo name and a predefined name associated with the plurality of sub-merchants, and a Card Acceptor Identifier (CAID) associated with each of the one or more payment facilitators; assign a plurality of pseudo acquirer identifiers to the sub-merchant data received from each of the one or more payment facilitators; and identify the one or more sub-merchants in the GMR by mapping the sub-merchant data with transaction data associated with a plurality of merchants in the GMR, based on the plurality of pseudo acquirer identifiers and the CAID associated with the respective payment facilitators.

Clause 9: The sub-merchant identification system of clause 8, wherein the plurality of pseudo acquirer identifiers comprises a Centre Information Block (CIB) and Bank Identification Number (BIN).

Clause 10: The sub-merchant identification system of clause 8 or 9, wherein the transaction data comprises a pre-stored CAID associated with the respective payment facilitators, a pre-stored pseudo name, a true name, and pre-stored acquirer identifiers associated with the plurality of sub-merchants.

Clause 11: The sub-merchant identification system of any of clauses 8-10, wherein the at least one processor is further programmed or configured to: prior to identifying the one or more sub-merchants in the GMR, eliminate noise data associated with corresponding pseudo names of the sub-merchants based on a predefined pattern matching technique.

Clause 12: The sub-merchant identification system of any of clauses 8-11, wherein, when identifying the one or more sub-merchants in the GMR, the at least one processor is programmed or configured to: identify a name and a location associated with the plurality of sub-merchants by mapping the sub-merchant data and the transaction data based on pseudo names of the sub-merchants and the CAID associated with the respective payment facilitators.

Clause 13: The sub-merchant identification system of any of clauses 8-12, wherein the sub-merchant data comprises a pseudo name and a predefined name associated with the plurality of sub-merchants.

Clause 14: The sub-merchant identification system of any of clauses 8-13, wherein the at least one processor is further programmed or configured to: store the sub-merchant data associated with the one or more sub-merchants and the CAID associated with each of the one or more payment facilitators in the GMR.

Clause 15: A computer program product for identifying sub-merchants within a Global Merchant Repository (GMR) comprising at least one non-transitory computer-readable medium comprising one or more instructions that, when executed by at least one processor, cause the at least one processor to: receive sub-merchant data associated with one or more sub-merchants, from one or more payment facilitators associated with a plurality of sub-merchants, wherein the sub-merchant data comprises a pseudo name and a predefined name associated with the plurality of sub-merchants, and a Card Acceptor Identifier (CAID) associated with each of the one or more payment facilitators; assign a plurality of pseudo acquirer identifiers to the sub-merchant data received from each of the one or more payment facilitators; and identify the one or more sub-merchants in the GMR by mapping the sub-merchant data with transaction data associated with a plurality of merchants in the GMR, based on the plurality of pseudo acquirer identifiers and the CAID associated with the respective payment facilitators.

Clause 16: The computer program product of clause 15, wherein the plurality of pseudo acquirer identifiers comprises a Centre Information Block (CIB) and a Bank Identification Number (BIN).

Clause 17: The computer program product of clause 15 or 16, wherein the transaction data comprises a pre-stored CAID associated with the respective payment facilitators, a pre-stored pseudo name, a true name, and pre-stored acquirer identifiers associated with the plurality of sub-merchants.

Clause 18: The computer program product of any of clauses 15-17, wherein the one or more instructions further cause the at least one processor to: prior to identifying the one or more sub-merchants in the GMR, eliminate noise data associated with corresponding pseudo names of the sub-merchants based on a predefined pattern matching technique.

Clause 19: The computer program product of any of clauses 15-18, wherein, the one or more instructions that cause the at least one processor to identify the one or more sub-merchants in the GMR, cause the at least one processor to: identify a name and a location associated with the plurality of sub-merchants by mapping the sub-merchant data and the transaction data based on pseudo names of the sub-merchants and the CAID associated with the respective payment facilitators.

Clause 20: The computer program product of any of clauses 15-19, wherein the one or more instructions further cause the at least one processor to: store the sub-merchant data associated with the or more sub-merchants and the CAID associated with each of the one or more payment facilitators in the GMR.

In some non-limiting embodiments or aspects, a method of identifying sub-merchants within a Global Merchant Repository (GMR) is disclosed. The method includes receiving sub-merchant data associated with one or more sub-merchants, from one or more payment facilitators associated with a plurality of sub-merchants. The sub-merchant data comprises a pseudo name and a predefined name associated with the plurality of sub-merchants and a Card Acceptor Identifier (CAID) associated with each of the one or more payment facilitators. Further, the method includes assigning a plurality of pseudo acquirer identifiers to the sub-merchant data received from each of the one or more payment facilitators. Thereafter, the method includes identifying the one or more sub-merchants in the GMR by mapping the sub-merchant data with transaction data associated with a plurality of merchants in the GMR, based on the plurality of pseudo acquirer identifiers and the CAID associated with the respective payment facilitators.

In some non-limiting embodiments or aspects, the plurality of pseudo acquirer identifiers comprises a Centre Information Block (CIB) and a Bank Identification Number (BIN).

In some non-limiting embodiments or aspects, the transaction data comprises a prestored CAID associated with the respective payment facilitators, a prestored pseudo name, a true name, and pre-stored acquirer identifiers associated with the plurality of sub-merchants.

In some non-limiting embodiments or aspects, prior to identifying the one or more sub-merchants in the GMR, noise data associated with corresponding pseudo names of the sub-merchants is eliminated based on a predefined pattern matching technique.

In some non-limiting embodiments or aspects, identifying the one or more sub-merchants in the GMR comprises identifying a name and a location associated with the plurality of sub-merchants by mapping the sub-merchant data and the transaction data based on pseudo names of the sub-merchants and the CAID associated with the respective payment facilitators.

In some non-limiting embodiments or aspects, a sub-merchant identification system is disclosed. The sub-merchant identification system comprises at least one processor programmed or configured to receive sub-merchant data associated with one or more sub-merchants, from one or more payment facilitators associated with the plurality of sub-merchants. The sub-merchant data comprises a pseudo name and a predefined name associated with the plurality of sub-merchants, and a CAID associated with each of the one or more payment facilitators. The sub-merchant identification system assigns a plurality of pseudo acquirer identifiers for each of the one or more payment facilitators. Thereafter, the sub-merchant identification system identifies the one or more sub-merchants in the GMR by mapping the sub-merchant data with transaction data associated with a plurality of merchants in the GMR, based on the plurality of pseudo acquirer identifiers and the CAID associated with the respective payment facilitators.

In some non-limiting embodiments or aspects, the plurality of pseudo acquirer identifiers comprises a CIB and a BIN.

In some non-limiting embodiments or aspects, the transaction data comprises a pre-stored CAID associated with the respective payment facilitators, a pre-stored pseudo name, a true name, and pre-stored acquirer identifiers associated with the plurality of sub-merchants.

In some non-limiting embodiments or aspects, the at least one processor is further programmed or configured to: prior to identifying the one or more sub-merchants in the GMR, eliminate noise data associated with corresponding pseudo names of the sub-merchants based on a predefined pattern matching technique.

In some non-limiting embodiments or aspects, when identifying the one or more sub-merchants in the GMR, the at least one processor is programmed or configured to: identify a name and a location associated with the plurality of sub-merchants by mapping the sub-merchant data and the transaction data based on pseudo names of the sub-merchants and the CAID associated with the respective payment facilitators.

In some non-limiting embodiments or aspects, the sub-merchant data comprises a pseudo name and a predefined name associated with the plurality of sub-merchants.

In some non-limiting embodiments or aspects, the at least one processor is further programmed or configured to: store the sub-merchant data associated with the one or more sub-merchants and a CAID associated with each of the one or more payment facilitators in the GMR.

In some non-limiting embodiments or aspects, a computer program product for identifying sub-merchants within a GMR comprising at least one non-transitory computer-readable medium comprising one or more instructions that, when executed by at least one processor, cause the at least one processor to: receive sub-merchant data associated with one or more sub-merchants, from one or more payment facilitators associated with the plurality of sub-merchants, wherein the sub-merchant data comprises a pseudo name and a predefined name, associated with the plurality of sub-merchants, and a CAID associated with each of the one or more payment facilitators; assign a plurality of pseudo acquirer identifiers to the sub-merchant data received from each of the one or more payment facilitators; and identify the one or more sub-merchants in the GMR by mapping the sub-merchant data with transaction data associated with a plurality of merchants in the GMR, based on the plurality of pseudo acquirer identifiers and the CAID associated with the respective payment facilitators.

In some non-limiting embodiments or aspects, the plurality of pseudo acquirer identifiers comprises a CIB and a BIN.

In some non-limiting embodiments or aspects, the transaction data comprises a pre-stored CAID associated with the respective payment facilitators, a pre-stored pseudo name, a true name, and pre-stored acquirer identifiers associated with the plurality of sub-merchants.

In some non-limiting embodiments or aspects, the one or more instructions further cause the at least one processor to: prior to identifying the one or more sub-merchants in the GMR, eliminate noise data associated with corresponding pseudo names of the sub-merchants based on a predefined pattern matching technique.

In some non-limiting embodiments or aspects, the one or more instructions that cause the at least one processor to identify the one or more sub-merchants in the GMR, cause the at least one processor to: identify a name and a location associated with the plurality of sub-merchants by mapping the sub-merchant data and the transaction data based on pseudo names of the sub-merchants and the CAID associated with the respective payment facilitators.

In some non-limiting embodiments or aspects, the one or more instructions further cause the at least one processor to: store the sub-merchant data associated with the one or more sub-merchants and a CAID, associated with each of the one or more payment facilitators in the GMR.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference features and components. Some non-limiting embodiments or aspects of systems, methods, and/or computer program products are now described, by way of example only, and with reference to the accompanying figures, in which:

FIG. 1 is a schematic view of a non-limiting embodiment or aspect of a process for identifying merchants in a Global Merchant Repository (GMR), in accordance with the present disclosure;

FIG. 2 is a schematic view of a non-limiting embodiment or aspect of an environment for identifying sub-merchants within the GMR, in accordance with the present disclosure;

FIG. 3 is a block diagram of a non-limiting embodiment or aspect of a sub-merchant identification system, in accordance with the present disclosure;

FIG. 4 is a diagram of clearing noise data from sub-merchant data in a non-limiting embodiment or aspect of the present disclosure;

FIG. 5 is a flow diagram of a non-limiting embodiment or aspect of a method of identifying sub-merchants within the GMR, in accordance with the present disclosure; and

FIG. 6 is a block diagram of a non-limiting embodiment or aspect of a sub-merchant identification system for identifying sub-merchants within the GMR, in accordance with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo codes, and the like represent various processes which may be substantially represented in computer readable medium and executed by a computer or processor, whether or not such a computer or processor is explicitly shown.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the description of the disclosure. It should also be realized by those skilled in the art that such equivalent systems and methods do not depart from the scope of the disclosure. The novel features which are believed to be characteristics of the disclosure, as to method of operation, together with further objects and advantages may be better understood from the following description when considered in connection with the accompanying figures.

It is to be expressly understood, however, that each of the figures is provided for the purpose of illustration and description only and is not intended as a definition of the limits of the present disclosure.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the figures and will be described in detail below. It should be understood, however, that it is not intended to limit the disclosure to the particular forms disclosed, but on the contrary, the disclosure is to cover all modifications, equivalents, and alternative falling within the scope of the disclosure.

As used herein, the terms “communication”, “communicate”, “send”, and/or “receive” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible. The term “programmed or configured to,” as used herein, may refer to an arrangement of software, device(s), and/or hardware for performing and/or enabling one or more functions (e.g., actions, processes, steps of a process, and/or the like). For example, “a processor programmed or configured to” may refer to a processor that executes software instructions (e.g., program code) that cause the processor to perform one or more functions.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has”, “have”, “having”, or the like are intended to be open-ended terms. Further, the phrase “based on” is intended to mean “based at least partially on” unless explicitly stated otherwise. The term “some non-limiting embodiments or aspects” means “one or more embodiments or aspects of the disclosure(s)” unless expressly specified otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the terms “server” and/or “processor” may refer to one or more computing devices or computing units, such as processors, storage devices, and/or similar computer components, that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as but not limited to, processors, servers, client devices, software applications, and/or other like components.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

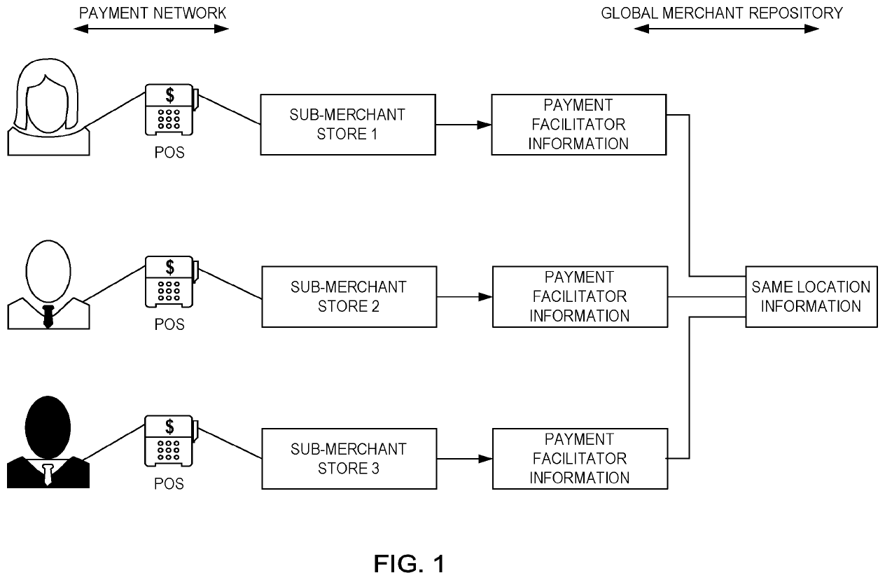

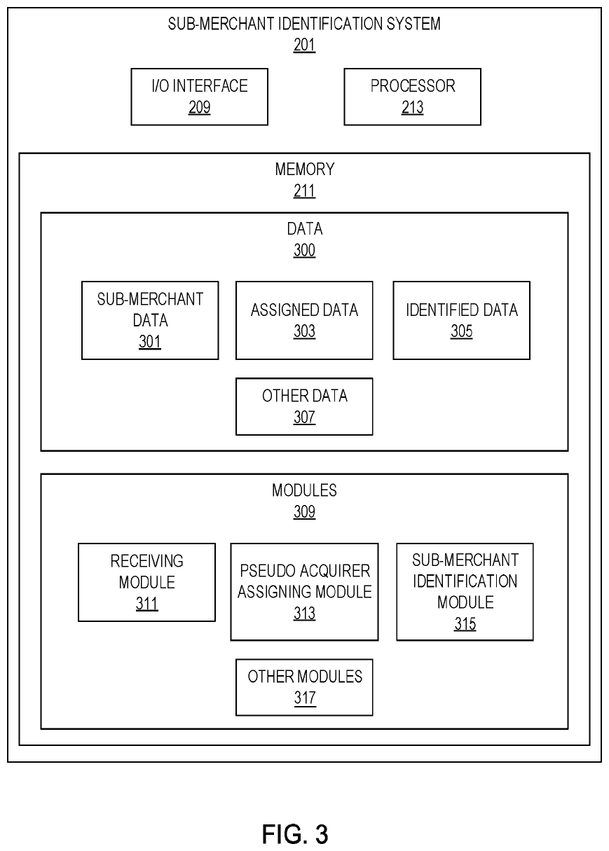

The following paragraphs describe the present disclosure with reference to FIGS. 1 to 6. In the figures, the same element or elements which have similar functions are indicated by the same reference signs.

Disclosed herein is a method and a sub-merchant identification system for identifying sub-merchants within a Global Merchant Repository (GMR). Currently, as merchants sponsored by the payment facilitators do not have the acquirer merchant identifiers, it becomes difficult to link these merchants with transaction data received from payment networks. Thus, currently the GMR is unable to link Acquirer Merchant Master File (AMMF) data received from the payment facilitators, with the corresponding transaction data, thereby creating a major problem in identifying the sub-merchants which are operating behind the payment facilitators. FIG. 1 illustrates a process of identifying merchants in a GMR. As shown in FIG. 1, the GMR may receive information associated with the one or more payment facilitators. The information may include, but not be limited to, brand name, headquarter address of the corresponding payment facilitators, and the like. As seen from FIG. 1, the GMR receives same location information associated with the corresponding payment facilitators, thereby failing to receive information associated with the one or more sub-merchants.

Therefore, to overcome problems, the present disclosure includes assigning a plurality of pseudo acquirer identifiers to sub-merchant data received from one or more payment facilitators. This leads to an indication as if the sub-merchant data is being received through an acquirer and enables linking the sub-merchant data with transaction data in the GMR. In this manner, the present disclosure identifies the sub-merchant in the GMR by mapping the sub-merchant data with the transaction data associated with a plurality of merchants in the GMR, based on the plurality of pseudo acquirer identifiers.

The present disclosure provides an ability to link the sub-merchant data received from the one or more payment facilitators with pre-stored transaction data, which is stored in the GMR. The present disclosure further facilitates the elimination of noise from the sub-merchant data for enhancing mapping of the sub-merchant data with the transaction data and, thereby, identifying the one or more sub-merchant within the GMR.

In the following detailed description of the embodiments of the disclosure, reference is made to the accompanying drawings that form a part hereof, and in which are shown by way of illustration specific embodiments in which the disclosure may be practiced. These non-limiting embodiments or aspects are described in sufficient detail to enable those skilled in the art to practice the disclosure, and it is to be understood that other embodiments or aspects may be utilized and that changes may be made without departing from the scope of the present disclosure. The following description is, therefore, not to be taken in a limiting sense.

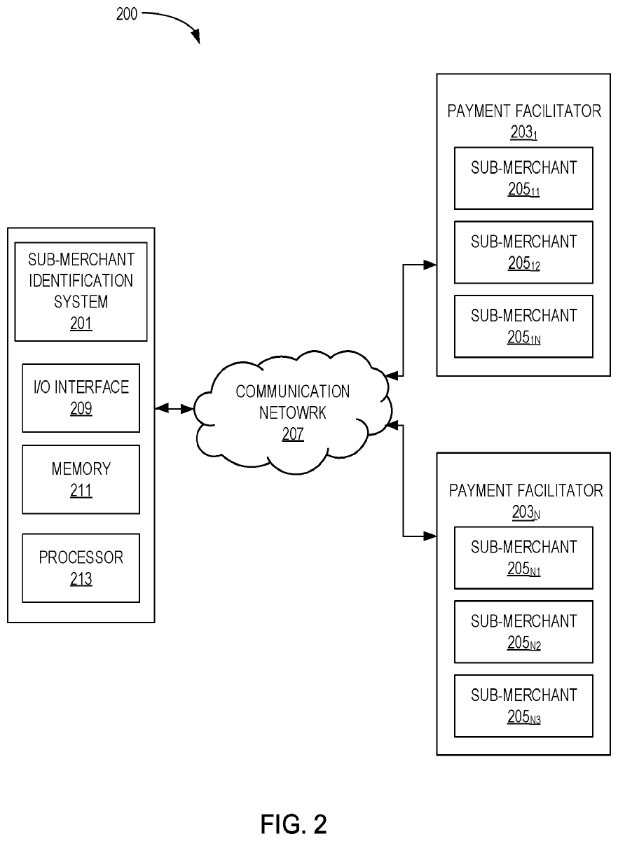

FIG. 2 illustrates a non-limiting embodiment or aspect of an environment for identifying sub-merchants within a Global Merchant Repository (GMR), in accordance with the present disclosure.

FIG. 2 shows an environment 200 associated with a payment system which includes a sub-merchant identification system 201 connected to one or more payment facilitators (e.g., a payment facilitator 2031, a payment facilitator 2032, etc., a payment facilitator 2031 through a payment facilitator 203N, collectively referred to as one or more payment facilitators 203). Each of the one or more payment facilitators 203 are associated with respective one or more sub-merchants 205. For instance, a payment facilitator 2031 is associated with a sub-merchant 20511, a sub-merchant 20512, a sub-merchant 2051N, and/or a a sub-merchant 205_{N}-205_{N3}. The one or more sub-merchants associated with each of the one or more payment facilitators 203 are collectively referred to as one or more sub-merchants 205. The one or more payment facilitators 203 may refer to a payment service provider which provides infrastructure to merchants for processing electronic payments. In some non-limiting embodiments or aspects, the one or more sub-merchants 205 may include small and medium-sized merchants. The payment facilitators 203 onboard the one or more sub-merchants 205 to provide them with technologies that are required to process electronic payments. On completing the onboarding process, the one or more sub-merchants 205 make use of electronic payment facilities provided by the one or more payment facilitators 203 to process the electronic payments. The one or more payment facilitators 203 interact with the sub-merchant identification system 201 through a communication network 207.

In some non-limiting embodiments or aspects, the sub-merchant identification system 201 may be implemented in a payment network which may be associated with the GMR. The GMR may be a database comprising pre-stored sub-merchant data comprising transaction details associated with various merchants. In some non-limiting embodiments or aspects, the GMR may be configured to handle datasets associated with the merchants by using techniques such as, information retrieval techniques, machine learning algorithms combined with Natural Language Processing (NLP) techniques, and the like. The sub-merchant identification system 201 may include an Input/Output (I/O) interface 209, a memory 211, and a processor 213, as shown in FIG. 2. The I/O interface 209 may receive sub-merchant data from the one or more payment facilitators 203 associated with the one or more sub-merchants 205. The sub-merchant identification system 201 may be implemented in any computing device such as, but not limited to, a desktop computer, a server, and the like. In some non-limiting embodiments or aspects, the sub-merchant identification system 201 may be implemented in a cloud. In the present disclosure, the sub-merchant identification system 201 identifies the one or more sub-merchants 205 within the GMR. The sub-merchant identification system 201 receives sub-merchant data associated with the one or more sub-merchants 205.

In some non-limiting embodiments or aspects, the sub-merchant data comprises a pseudo name and a predefined name, which are associated with the respective sub-merchants 205. For example, the pseudo name may relate to a BASE II name, and the predefined name may relate to a Doing Business As (DBA) Name which are given to the one or more sub-merchants 205. The sub-merchant data further comprises a Card Acceptor Identifier (CAID), associated with each of the one or more payment facilitators 203.

In some non-limiting embodiments or aspects, unlike directly acquired merchants i.e., merchants acquired directly by banks, the one or more sub-merchants 205 do not include acquirer merchant identifiers, such as Centre Information Blocks (CIBs) identifier, Bank Identification Numbers (BINs) identifier, and CAIDs. Herein, the BIN identifiers relate to first four to six numbers on a payment card. This set of numbers identify corresponding financial institutions that issue a payment card. Particularly, a BIN identifier is used for matching transaction information with corresponding issuers of the payment card. The CAID identifiers relate to an identification value used by banks to identify a location associated with card acceptor terminals. Therefore, the CIB identifier, the BIN identifier, and the CAID identifier are crucial for performing identification of the one or more sub-merchants 205. As an example, Table 1 below shows exemplary merchant data associated with a regular acquirer merchant. Further, Table 2 shows exemplary sub-merchant data associated with a payment facilitator sponsored merchant (sub-merchant).

TABLE 1
Merchant data - Regular Acquirer Merchant

| CIB | BIN | CAID | Pseudo Name | Predefined Name |
|---|---|---|---|---|
| 425023 | 425023 | 171476 | MARTIN JOE | MARTIN JOE |
| | | | MORENO | MORENO |
| 425023 | 425023 | 171477 | Flo Ring Medical | Flo Ring Medical |
| | | | Ser | Ser |
| 425023 | 425023 | 171478 | FELLOWS CLUB | FELLOWS CLUB |
| | | | OF SEA TR | OF SEA TR |

TABLE 2
Sub-merchant data - Payment Facilitator sponsored Merchant

| CIB | BIN | CAID | Pseudo Name | Predefined Name |
|---|---|---|---|---|
| — | — | 184141174904 | SQ *BIG STACK | BIG STACK |
| | | | BARBERSHOP | BARBERSHOP |
| — | — | 184141174904 | SQ *FAMOUS | FAMOUS |
| | | | GRADES | GRADES |
| — | — | 184141174904 | SQ *CUPCAKES | CUPCAKES & |
| | | | & GEMS LLC | GEMS LLC |

From Table 1 and Table 2, as shown above, it is clear that the sub-merchant data received from the one or more payment facilitators 203 lack the CIB and the BIN identifiers for transactions initiated by the payment facilitator (“PF” in Table 3) sponsored merchants. Therefore, in some non-limiting embodiments or aspects, based on receiving the sub-merchant data, the sub-merchant identification system 201 assigns a plurality of pseudo acquirer identifiers to the received sub-merchant data. The plurality of pseudo acquirer identifiers comprises a CIB identifier and a BIN identifier. Herein, on assigning the plurality of pseudo acquirer identifiers to the received sub-merchant data, the sub-merchant data demonstrates a behaviour like that of acquirer merchant data, which comprises true values associated with CIBs, BINs, and CAIDs. Table 3 below shows exemplary pseudo acquirer identifiers, such as the CIB and the BIN being assigned to remould the sub-merchant data as the acquirer merchant data.

TABLE 3

| | | CIB | BIN |
|---|---|---|---|
| PF Identifier | PF Name | Assigned | Assigned |
| 10080749 | OTP Exan PPT | 199220 | 199220 |
| 10079020 | BB2XBB Company Digital | 199221 | 199221 |
| | S.A. | | |
| 10078161 | PaySpears LLC | 199222 | 199222 |
| 10076728 | Round, Inc. | 199223 | 199223 |

In some non-limiting embodiments or aspects, the sub-merchant identification system 201 may eliminate noise associated with the corresponding pseudo names of the one or more sub-merchants 205, prior to identifying the one or more sub-merchants 205 in the GMR. The elimination may be performed based on a predefined pattern matching technique. In some non-limiting embodiments or aspects, the predefined matching technique may include, but is not limited to, regular expression matching, string matching, and the like. The sub-merchant identification system 201 may identify a unique pattern associated with the pseudo name of the one or more sub-merchants 205. The unique pattern associated with each of the one or more sub-merchants 205 may be stored with the sub-merchant identification system 201. The sub-merchant identification system 201 identifies the sub-merchants based on a comparison of the pseudo names associated with the one or more sub-merchants 205 with the prestored patterns. In some non-limiting embodiments or aspects, the noise associated with the transaction data, such as the prestored pseudo names, may be eliminated by the sub-merchant identification system 201.

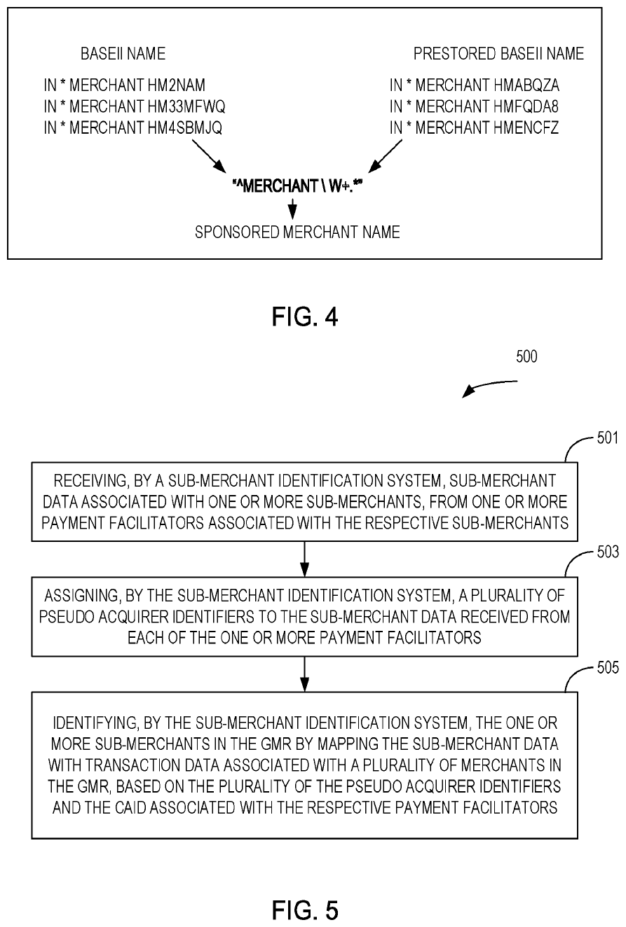

Non-limiting embodiments or aspects of a noise elimination process from sub-merchant data is illustrated in FIG. 4. As seen from FIG. 4, the sub-merchant identification system 201 may perform elimination of noise for the BASE II names associated with the sub-merchant data and the transaction data which is prestored in the GMR. Further, from FIG. 4, it is seen that the merchant name is followed by certain noise data or junk characters. For example, “IN *MERCHANT HM2NAM”, wherein HM2NAM corresponds to noise/junk data. Therefore, using the predefined pattern matching techniques, the sub-merchant identification system 201 clears the noise data and generates a unique pattern for the corresponding pseudo name. As shown in FIG. 4, the generated unique pattern for the BASE II name which is associated with the noise data “HM2NAM” corresponds to “MERCHANT\W+.*”. Therefore, when the sub-merchant identification system 201 detects a BASE II name with a similar pattern, the corresponding sub-merchant associated with the BASE II name may be determined. As shown in FIG. 4, the merchant's name corresponds to “IN *MERCHANT”.

Thus, eliminating the noise data or junk characters from BASE II of merchants facilitates the sub-merchant identification system 201 to easily map the sub-merchant data with the transaction data for identifying the one or more sub-merchants 205. Table 4 below shows an exemplary illustration of generated unique patterns on performing elimination of junk characters associated with the pseudo names of sub-merchants. As seen from Table 6, based on the generated patterns, the corresponding merchants may be determined.

TABLE 4

| | Generated Pattern | |
|---|---|---|
| Pattern ID | (without noise) | Merchant |
| 1 | \hat{ }WATERBMB\W+.* | WATERBMB |
| 2 | \hat{ }CLASSIRAINC\W+.* | CLASSIRA |
| 3 | \hat{ }HELPCLASSIR\W+.* | CLASSIRA |
| 4 | \hat{ }BILLYWORLD\W+.* | BILLYWORLD+ |
| 5 | \hat{ } BILLYWORLD\W+.* | BILLYWORLD |
| 6 | \hat{ }OMNIDOES\W+.* | OMNIDOES |
| 7 | \hat{ }HEADPG\W+.* | HEADPAGE |

As seen from Table 6, the listed merchants are easily identifiable after the sub-merchant identification system 201 performs elimination of junk characters.

In some non-limiting embodiments or aspects, based on assigning the plurality of pseudo acquirer identifiers to the sub-merchant data, the sub-merchant identification system 201 may use the plurality of pseudo acquirer identifiers and the CAID associated with the respective payment facilitators 203 to identify the one or more sub-merchants 205 in the GMR. Then, the sub-merchant identification system 201 may perform a mapping of the sub-merchant data with transaction data (clearing and settlement data of transactions) associated with a plurality of merchants which includes the acquirer merchants and the payment facilitator sponsored merchants present in the GMR. In some non-limiting embodiments or aspects, the transaction data may include, but is not limited to, a prestored CAID associated with the respective one or more payment facilitators 203, a pre-stored pseudo name, a true name, and prestored acquirer identifiers, which are associated with the respective one or more sub-merchants 205.

In some non-limiting embodiments or aspects, the sub-merchant identification system 201 may use the pseudo acquirer identifiers, the CAID identifier, and the pseudo names, associated with the sub-merchant data, to perform the mapping of the sub-merchant data with the transaction data associated with the plurality of merchants in the GMR. Table 5 below shows exemplary sub-merchant data with the assigned pseudo acquirer identifiers and Table 6 shows exemplary transaction data in the GMR.

TABLE 5
Sub-merchant data - Payment Facilitator sponsored Merchant

| CIB | BIN | CAID | Pseudo Name | Predefined Name |
|---|---|---|---|---|
| 189041 | 189041 | 174030074994 | SQ *BIG | BIG CHIMNEY |
| | | | CHIMNEY | BARBERSHOP |
| | | | BARBERSHOP | |
| 189041 | 189041 | 174030074994 | SQ *FAMOUS | FAMOUS |
| | | | FADEZ | FADEZ |
| 189041 | 189041 | 174030074994 | SQ *CUPCAKES | CUPCAKES & |
| | | | & CARATS LLC | CARATS LLC |

TABLE 6
Transaction data - Payment Facilitator sponsored Merchant

| Prestored- | Prestored- | Prestored- | Prestored- | Prestored- |
|---|---|---|---|---|
| CIB | BIN | CAID | Pseudo Name | Name |
| 189041 | 189041 | 174030074994 | SQ *BIG | BIG |
| | | | CHIMNEY | CHIMNEY |
| | | | BARBER- | BARBER- |
| | | | SHOP | SHOP |
| 189041 | 189041 | 174030074994 | SQ *FAMOUS | FAMOUS |
| | | | FADEZ | FADEZ |
| 189041 | 189041 | 174030074994 | SQ | CUPCAKES |
| | | | *CUPCAKES | & CARATS |
| | | | & CARATS | LLC |
| | | | LLC | |

As seen from Table 5 and Table 6, on assigning the pseudo acquirer identifiers to the sub-merchant data, the sub-merchant identification system 201 can easily map the sub-merchant data to the transaction data. Thus, the sub-merchant identification system 201 identifies the one or more sub-merchants 205 associated with the one or more payment facilitators 203 based on the mapping. Particularly, based on the mapping, the sub-merchant identification system 201 may identify a name and a location associated with the respective sub-merchants 205 based on the pseudo names of the sub-merchants 205 and the CAID identifier associated with the respective payment facilitators.

Thus, the present disclosure provides an ability to link the sub-merchant data received from the one or more payment facilitators 203 with the transaction data which is stored in the GMR. The present disclosure further facilitates elimination of the noise data from the pseudo names of the sub-merchants 205 for enhancing mapping of the sub-merchant data with the transaction data and, thereby, identifying the one or more sub-merchants 205 within the GMR.

FIG. 2 illustrates a non-limiting embodiment or aspect of a detailed block diagram of a sub-merchant identification system, in accordance with the present disclosure.

In some non-limiting embodiments or aspects, the sub-merchant identification system 201 may include data 300 and modules 309. As an example, the data 300 is stored in the memory 211 associated with the sub-merchant identification system 201. In some embodiments, the data 300 may include sub-merchant data 301, assigned data 303, identified data 305, and other data 307. In some embodiments, the data 300 may be stored in the memory 211 in the form of various data structures.

In some non-limiting embodiments or aspects, the sub-merchant data 301 may include, but is not limited to, a pseudo name and a predefined name, associated with the respective sub-merchants 205, and the CAID, associated with each of the one or more payment facilitators 203. The pseudo name may correspond to a BASE II name, and the predefined name may correspond to a Doing Business As (DBA) Name.

In some non-limiting embodiments or aspects, the assigned data 303 may include a plurality of pseudo acquirer identifiers which are assigned to the sub-merchant data 301. The plurality of pseudo acquirer identifiers may the CIB identifier and the BIN identifier.

In some non-limiting embodiments or aspects, the identified data 305 may include details of the one or more sub-merchants 205 identified in the GMR on performing mapping of the sub-merchant data 301 with transaction data. The details may include a name and a location which are identified based on the mapping.

In some non-limiting embodiments or aspects, the other data 307 may be stored data, including temporary data and temporary files, generated by the modules 309 for performing the various functions of the sub-merchant identification system 201.

In some non-limiting embodiments or aspects, the data 300 in the memory 211 are processed by the one or more modules 309 present within the memory 211 of the sub-merchant identification system 201.

In some non-limiting embodiments or aspects, one or more modules 309, along with the data 300, functions to identify sub-merchants within the GMR. In one implementation, the one or more modules 309 may include, but are not limited to, a receiving module 311, a pseudo acquirer assigning module 313, a sub-merchant identification module 315, and one or more other modules 317.

In some non-limiting embodiments or aspects, the one or more modules 309 may be implemented as dedicated units. As used herein, the term module refers to an application specific integrated circuit (ASIC), an electronic circuit, a field-programmable gate arrays (FPGA), programmable system-on-chip (PSoC), a combinational logic circuit, and/or other suitable components that provide the described functionality. In some implementations, the one or more modules 309 may be communicatively coupled to the processor 213 for performing one or more functions of the sub-merchant identification system 201. The modules 309, when configured with the functionality defined in the present disclosure, will result in a novel hardware.

In some non-limiting embodiments or aspects, the receiving module 311 is configured to receive the sub-merchant data 301 associated with the one or more sub-merchants 205, from the one or more payment facilitators 203 associated with the respective one or more sub-merchants 205.

In some non-limiting embodiments or aspects, the pseudo acquirer assigning module 313 is configured to receive the sub-merchant data 301. Upon receiving the sub-merchant data 301, the pseudo acquirer assigning module 313 internally assigns the plurality of pseudo acquirer identifiers to the sub-merchant data 301. The pseudo acquirer assigning module 313 assigns the plurality of pseudo acquirer identifiers to the sub-merchant data 301, such that the sub-merchant data 301 is consistent with existing processing systems that process merchant data associated with acquirers. Therefore, the pseudo acquirer assigning module 313 assigns the CIB identifier and the BIN identifier to the sub-merchant data 301. In an example, Table 3 above shows exemplary pseudo acquirers assigned to the sub-merchant data.

In some non-limiting embodiments or aspects, the sub-merchant identification module 315 is configured to identify the one or more sub-merchants 205 in the GMR. The sub-merchant identification module 315 performs the identification by mapping the sub-merchant data 301 with transaction data which is associated with a plurality of merchants in the GMR. The sub-merchant identification module 315 performs the mapping based on the plurality of pseudo acquirer identifiers and the CAID identifier associated with the respective one or more payment facilitators 203. For example, the sub-merchant identification module 315 may link a CAID identifier and a pseudo name associated with a payment facilitator, to a pre-stored CAID identifier and a prestored pseudo name, in the GMR. The sub-merchant identification module 315 may further be configured to identify the name and the location of the sub-merchants 205 based on the prestored CAID identifier and the prestored pseudo name associated with the one or more sub-merchants 205 in the GMR. Thus, the sub-merchant identification module 315 identifies the sub-merchants 205 based on the plurality of pseudo acquirer identifiers, the CAID identifier, and the pseudo name.

In some non-limiting embodiments or aspects, the one or more other modules 317 may be used to perform various miscellaneous functionalities of the sub-merchant identification system 201. For instance, the one or more other modules 317 may include a noise elimination module and a pattern matching module. Particularly, the noise elimination module may be configured to perform elimination of noise from pseudo names associated with the sub-merchant data. Further, the pattern matching module may be configured to receive the sub-merchant data 301 from the pseudo acquirer assigning module 313 and perform pattern matching to generate a unique pattern for the pseudo name associated with the corresponding sub-merchant. For example, Table 6 above shows the elimination of junk characters associated with the pseudo names of the one or more sub-merchants 205.

FIG. 5 illustrates a non-limiting embodiment or aspect of a flowchart showing a method of identifying sub-merchants within the GMR, in accordance with the present disclosure.

As illustrated in FIG. 5, the method 500 comprises one or more blocks illustrating a method of identifying sub-merchants within the GMR, in accordance with the present disclosure. The method 500 may be described in the general context of computer-executable instructions. Generally, computer-executable instructions can include routines, programs, objects, components, data structures, procedures, modules, and functions, which perform functions or implement abstract data types.

In some non-limiting embodiments or aspects, the order in which the method 500 is described is not intended to be construed as a limitation, and any number of the described method blocks can be combined in any order to implement the method 500. Additionally, individual blocks may be deleted from the methods without departing from the scope of the subject matter described herein. Furthermore, the method 500 can be implemented in any suitable hardware, firmware, or a combination of hardware and software.

In some non-limiting embodiments or aspects, at block 501, the method 500 may include receiving, by a sub-merchant identification system 201, sub-merchant data associated with one or more sub-merchants 205, from one or more payment facilitators 203 associated with the respective sub-merchants 205. The sub-merchant data comprises a pseudo name and a predefined name, associated with the respective sub-merchants 205, and the CAID, associated with each of the one or more payment facilitators 203.

In some non-limiting embodiments or aspects, at block 503, the method 500 may include assigning, by the sub-merchant identification system 201, a plurality of pseudo acquirer identifiers to the sub-merchant data received from each of the one or more payment facilitators 203. The plurality of pseudo acquirer identifiers comprises the CIB and the BIN.

In some non-limiting embodiments or aspects, at block 505, the method 500 may include identifying, by the sub-merchant identification system 201, the one or more sub-merchants 205 in the GMR by mapping the sub-merchant data with transaction data associated with a plurality of merchants in the GMR, based on the plurality of pseudo acquirer identifiers and the CAID associated with the respective payment facilitators 203. The transaction data comprises a prestored CAID associated with the respective payment facilitators 203, a prestored pseudo name, a true name, and pre-stored acquirer identifiers associated with the plurality of sub-merchants (e.g., respective sub-merchants). Particularly, a name and a location associated with the plurality of sub-merchants 205 are identified by mapping the sub-merchant data and the transaction data based on the pseudo names of the sub-merchants and the CAID associated with the respective payment facilitators 203.

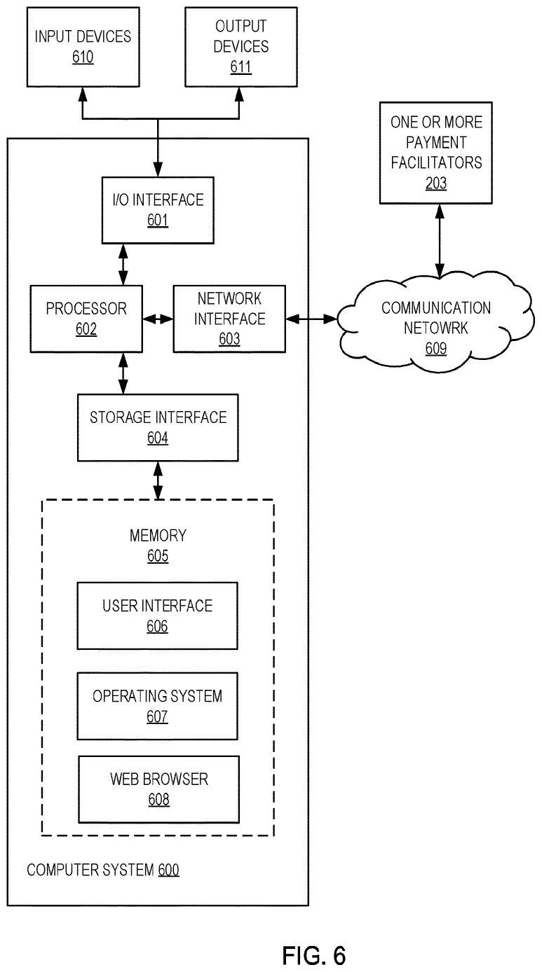

FIG. 6 is a block diagram of a non-limiting embodiment or aspect of a computer system for implementing the present disclosure.

FIG. 6 illustrates a block diagram of a non-limiting embodiment or aspect of a computer system 600 for implementing the present disclosure. In some embodiments, the computer system 600 may be a sub-merchant identification system 201 that comprises a processor 602 that is used for identifying sub-merchants within the GMR. The processor 602 may include at least one data processor for executing program components for executing user or system-generated business processes. The processor 602 may include specialized processing units, such as integrated system (bus) controllers, memory management control units, floating point units, graphics processing units, digital signal processing units, etc.

In some non-limiting embodiments or aspects, the processor 602 may be disposed in communication with input devices 610 and output devices 611 via an I/O interface 601. The I/O interface 601 may employ communication protocols/methods, such as without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc. Using the I/O interface 601, the computer system 600 may communicate with input devices 610 and output devices 611.

In some non-limiting embodiments or aspects, the processor 602 may be disposed in communication with a communication network 609 via a network interface 603. The network interface 603 may communicate with the communication network 609. The network interface 603 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 603 and the communication network 609, the computer system 600 may communicate with one or more payment facilitators 203 associated with one or more sub-merchants 205.

In some non-limiting embodiments or aspects, the communication network 609 can be implemented as one of the different types of networks, such as intranet or Local Area Network (LAN) and such within the organization. The communication network 609 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

In some non-limiting embodiments or aspects, the communication network 609 may include a variety of network devices, including routers, bridges, servers, computing devices, storage devices, etc. In some embodiments, the processor 602 may be disposed in communication with a memory 605 (e.g., RAM, ROM, etc. not shown in FIG. 6) via a storage interface 604. The storage interface 604 may connect to the memory 605 including, without limitation, memory drives, removable disc drives, etc., employing connection protocols, such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

In some non-limiting embodiments or aspects, the memory 605 may store a collection of program or database components, including, without limitation, a user interface 606, an operating system 607, a web browser 608, etc. In some embodiments, the computer system 600 may store user/application data, such as the data, variables, records, etc. as described in the present disclosure. Such databases may be implemented as fault-tolerant, relational, scalable, secure databases, such as Oracle or Sybase.

In some non-limiting embodiments or aspects, the operating system 607 may facilitate resource management and operation of the computer system 600. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like. The user interface 606 may facilitate display, execution, interaction, manipulation, or operation of program components through textual or graphical facilities. For example, user interfaces may provide computer interaction interface elements on a display system operatively connected to the computer system 600, such as cursors, icons, check boxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some non-limiting embodiments or aspects, the computer system 600 may implement the web browser 608 stored program components. The web browser 608 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. The web browsers 608 may utilize facilities, such as AJAX, DHTML, ADOBE® FLASH®, JAVASCRIPT®, JAVA®, Application Programming Interfaces (APIs), etc. The computer system 600 may implement a mail server stored program component. The mail server may be an Internet mail server, such as Microsoft Exchange or the like. The mail server may utilize facilities, such as ASP, ACTIVEX®, ANSI® C++/C#, MICROSOFT®, NET, CGI SCRIPTS, JAVA®, JAVASCRIPT®, PERL®, PHP, PYTHON®, WEBOBJECTS®, etc. The mail server may utilize communication protocols, such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 600 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

In some non-limiting embodiments or aspects, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

In some non-limiting embodiments or aspects, the present disclosure provides an ability to link sub-merchant data received from one or more payment facilitators 203 with the transaction data which is stored in the GMR. The present disclosure further facilitates elimination of noise data from pseudo names of the sub-merchants 205 for enhancing mapping of the sub-merchant data with the transaction data. Therefore, the present disclosure eliminates the problems associated with mapping the sub-merchant data with the transaction data in the GMR by making the sub-merchant data consistent with existing processing systems that process merchant data associated with acquirers.

In some non-limiting embodiments or aspects, a description of an embodiment with several components in communication with each other does not imply that all such components are required. On the contrary, a variety of optional components are described to illustrate the wide variety of possible embodiments of the present disclosure. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the present disclosure need not include the device itself.

An “article of manufacture” includes non-transitory computer-readable medium and/or hardware logic in which a code may be implemented. A device in which the code implementing the described embodiments of operations is encoded may include a computer-readable medium or hardware logic. Of course, those skilled in the art will recognize that many modifications may be made to this configuration without departing from the scope of the disclosure, and that the article of manufacture may include suitable information bearing medium known in the art.

The specification has described a system, a method, and a computer program product for identifying sub-merchants within the GMR. The illustrated steps are set out to explain the exemplary embodiments shown. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is, therefore, intended that the scope of the present disclosure be limited not by this detailed description, but rather by any claims that issue on an application based here on. Accordingly, the embodiments of the present disclosure are intended to be illustrative, but not limiting, of the scope of the present disclosure, which is set forth in the following claims.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method for identifying sub-merchants within a Global Merchant Repository (GMR), the method comprising:
receiving, by at least one processor and from one or more payment facilitators associated with a plurality of sub-merchants, sub-merchant data associated with one or more sub-merchants and a Card Acceptor Identifier (CAID) associated with each of the one or more payment facilitators;
assigning, by the at least one processor, a plurality of pseudo acquirer identifiers to the sub-merchant data received from each of the one or more payment facilitators; and
identifying, by the at least one processor, the one or more sub-merchants in the GMR by mapping the sub-merchant data with transaction data associated with a plurality of merchants in the GMR, based on the plurality of pseudo acquirer identifiers and the CAID associated with the respective payment facilitators.

2. The method of claim 1, wherein the plurality of pseudo acquirer identifiers comprises a Centre Information Block (CIB) and a Bank Identification Number (BIN).

3. The method of claim 1, wherein the transaction data comprises a pre-stored CAID associated with the respective payment facilitators, a prestored pseudo name, a true name, and pre-stored acquirer identifiers associated with the plurality of sub-merchants.

4. The method of claim 1, further comprising:
prior to identifying the one or more sub-merchants in the GMR, eliminating noise data associated with corresponding pseudo names of the sub-merchants based on a predefined pattern matching technique.

5. The method of claim 1, wherein identifying the one or more sub-merchants in the GMR comprises identifying a name and a location associated with the plurality of sub-merchants by mapping the sub-merchant data and the transaction data based on pseudo names of the sub-merchants and the CAID associated with the respective payment facilitators.

6. The method of claim 1, wherein the sub-merchant data comprises a pseudo name and a predefined name associated with the plurality of sub-merchants.

7. The method of claim 1, further comprising:
storing the sub-merchant data associated with the one or more sub-merchants and the CAID associated with each of the one or more payment facilitators in the GMR.

8. A sub-merchant identification system for identifying sub-merchants within a Global Merchant Repository (GMR), comprising:
at least one processor programmed or configured to:
receive sub-merchant data associated with one or more sub-merchants, from one or more payment facilitators associated with a plurality sub-merchants, wherein the sub-merchant data comprises a pseudo name and a predefined name associated with the plurality of sub-merchants, and a Card Acceptor Identifier (CAID) associated with each of the one or more payment facilitators;
assign a plurality of pseudo acquirer identifiers to the sub-merchant data received from each of the one or more payment facilitators; and
identify the one or more sub-merchants in the GMR by mapping the sub-merchant data with transaction data associated with a plurality of merchants in the GMR, based on the plurality of pseudo acquirer identifiers and the CAID associated with the respective payment facilitators.

9. The sub-merchant identification system of claim 8, wherein the plurality of pseudo acquirer identifiers comprises a Centre Information Block (CIB) and a Bank Identification Number (BIN).

10. The sub-merchant identification system of claim 8, wherein the transaction data comprises a prestored CAID associated with the respective payment facilitators, a prestored pseudo name, a true name, and prestored acquirer identifiers associated with the plurality of sub-merchants.

11. The sub-merchant identification system of claim 8, wherein the at least one processor is further programmed or configured to:
prior to identifying the one or more sub-merchants in the GMR, eliminate noise data associated with corresponding pseudo names of the sub-merchants based on a predefined pattern matching technique.

12. The sub-merchant identification system of claim 8, wherein, when identifying the one or more sub-merchants in the GMR, the at least one processor is programmed or configured to identify a name and a location associated with the plurality of sub-merchants by mapping the sub-merchant data and the transaction data based on pseudo names of the sub-merchants and the CAID associated with the respective payment facilitators.

13. The sub-merchant identification system of claim 8, wherein the sub-merchant data comprises a pseudo name and a predefined name associated with the plurality of sub-merchants.

14. The sub-merchant identification system of claim 8, wherein the at least one processor is further programmed or configured to store the sub-merchant data associated with one or more sub-merchants and the CAID associated with each of the one or more payment facilitators in the GMR.

15. A computer program product for identifying sub-merchants within a Global Merchant Repository (GMR) comprising at least one non-transitory computer-readable medium comprising one or more instructions that, when executed by at least one processor, cause the at least one processor to:
receive sub-merchant data associated with one or more sub-merchants, from one or more payment facilitators associated with a plurality of sub-merchants, wherein the sub-merchant data comprises a pseudo name and a predefined name associated with the plurality of sub-merchants, and a Card Acceptor Identifier (CAID) associated with each of the one or more payment facilitators;
assign a plurality of pseudo acquirer identifiers to the sub-merchant data received from each of the one or more payment facilitators; and
identify the one or more sub-merchants in the GMR by mapping the sub-merchant data with transaction data associated with a plurality of merchants in the GMR, based on the plurality of pseudo acquirer identifiers and the CAID associated with the respective payment facilitators.

16. The computer program product of claim 15, wherein the plurality of pseudo acquirer identifiers comprises a Centre Information Block (CIB) and a Bank Identification Number (BIN).

17. The computer program product of claim 15, wherein the transaction data comprises a pre-stored CAID associated with the respective payment facilitators, a pre-stored pseudo name, a true name, and pre-stored acquirer identifiers associated with the plurality of sub-merchants.

18. The computer program product of claim 15, wherein the one or more instructions further cause the at least one processor to:
prior to identifying the one or more sub-merchants in the GMR, eliminate noise data associated with corresponding pseudo names of the sub-merchants based on a predefined pattern matching technique.

19. The computer program product of claim 15, wherein, the one or more instructions that cause the at least one processor to identify the one or more sub-merchants in the GMR, cause the at least one processor to identify a name and a location associated with the plurality of sub-merchants by mapping the sub-merchant data and the transaction data based on pseudo names of the sub-merchants and the CAID associated with the respective payment facilitators.

20. The computer program product of claim 15, wherein the one or more instructions further cause the at least one processor to store the sub-merchant data associated with the one or more sub-merchants and the CAID associated with each of the one or more payment facilitators in the GMR.
